(19) United States
(12) Patent Application Publication
(10) Pub. No.: US 2005/0138323 A1
(43) Pub. Date: Jun. 23, 2005

(54) Accumulator shadow register systems and methods

(75) Inventor: Walter Lee Snyder, San Jose, CA (US)

Correspondence Address: JUNG-HUA KUO;C/O PORTFOLIOIP, P. O. BOX 52050, MINNEAPOLIS, MN, 55402, US

(73) Assignee: Intel Corporation, A DELAWARE CORPORATION, Santa Clara, CA (US)

(21) Appl. No.: 10/739,419

(22) Filed: Dec. 18, 2003

(51) Int. Cl. G06F 15/00

(52) U.S. Cl. 712/1

(57) ABSTRACT

Systems and methods are disclosed for facilitating communication between execution units in a processor. In one embodiment, an integer unit is provided with a set of shadow registers corresponding to each of a plurality of datapath units. Each shadow register is communicatively coupled to a datapath unit, and contains a copy of the contents of the datapath unit's accumulator register. When data is written to a datapath unit's accumulator register, it is also written to a shadow register in the integer unit, where it can be used by the integer unit in further computations.

### BACKGROUND

The proliferation of computer networks has led to an increasing demand for high-performance computing systems. For example, there is a growing demand for computing devices capable of handling multiple communications protocols, thereby enabling a single device—such as a personal computer, cellular telephone, personal digital assistant (PDA), or the like—to switch seamlessly between any of a variety of communication protocols (e.g., 802.11, General Packet Radio Service (GPRS), Bluetooth, Ultra Wideband (UWB), etc.). Such a capability might, for example, enable a user to maintain a continuous connection to the Internet or a virtual private network (VPN) as the user moved his laptop computer between a cable modem connection in his apartment, to a wireless local area network (WLAN) connection in his apartment complex, to a mobile connection while riding the train to work, to a local area network connection at his office. As another example, the ability to switch between a variety of communication protocols may be useful on a business trip, as a user moves between countries or regions that have adopted different communications standards.

Computer systems typically include a combination of hardware and software, although the relative roles and proportions of each will often vary among systems. Software-based systems typically operate by executing computer-readable instructions on general-purpose hardware. Hardware-based systems, on the other hand, are typically comprised of circuitry specially designed to perform specific operations (e.g., application specific integrated circuits (ASICs)). As a result, hardware-based systems generally have higher performance than software-based systems, although they also typically lack the flexibility to perform tasks other than the specific task(s) for which they were designed.

Reconfigurable systems represent a hybrid approach, in which software is used to reconfigure specially designed hardware to achieve performance approaching that offered by custom hardware. Reconfigurable systems also provide the flexibility of software-based systems, including the ability to adapt to new requirements, protocols, and standards. Thus, for example, a reconfigurable system could be used to efficiently process a variety of communications protocols, without the need for dedicated, ASIC-based digital signal processors (DSPs) for each protocol, resulting in savings in chip-size, cost, and/or power consumption.

### BRIEF DESCRIPTION OF THE DRAWINGS

Reference will be made to the following drawings, in which:

FIG. 1 is a diagram of a processor having multiple execution units.

FIG. 2 illustrates a process for communicating between execution units in a processing device such as that shown in FIG. 1.

FIG. 3 is an illustration of a system that includes one or more processors such as that shown in FIG. 1.

### DESCRIPTION OF SPECIFIC EMBODIMENTS

Systems and methods are disclosed for improving the integration of processing components in multi-processing unit systems, such as programmable or reconfigurable processors. It should be appreciated that these systems and methods can be implemented in numerous ways, several examples of which are described below. The following description is presented to enable any person skilled in the art to make and use the inventive body of work. The general principles defined herein may be applied to other embodiments and applications. Descriptions of specific embodiments and applications are thus provided only as examples, and various modifications will be readily apparent to those skilled in the art. For example, although several examples are provided in the context of the reconfigurable communications architecture, it will be appreciated that the same principles can be readily applied to other contexts as well. Accordingly, the following description is to be accorded the widest scope, encompassing numerous alternatives, modifications, and equivalents. For purposes of clarity, technical material that is known in the art has not been described in detail so as not to unnecessarily obscure the inventive body of work.

In some computer architectures, multiple execution units are used to perform complex calculations, with the results generated by one execution unit used as input to other execution units. Calculations can thus be divided among hardware elements, such that different parts of a calculation are assigned to the execution units upon which they are most efficiently carried out.

For example, the physical layer processing performed by many wireless and wired communications systems often involves a combination of numerically intensive computations and somewhat less intensive, but more general-purpose, computations. This is particularly true of protocols that use packetized data where fast acquisition is often needed. For example, processing a 802.11 a preamble typically entails fast preamble detection, fast automatic gain control (AGC) adjustment, and fast timing synchronization. These computations can advantageously be performed by processors that include a combination of datapath execution units capable of efficiently performing the intensive numerical computations, and integer units capable of performing the general purpose computations, preferably operating in parallel to reduce latency and enhance overall system performance.

When multiple execution units operate in parallel to perform a given function, it will often be desirable to pass intermediate results from one execution unit to another. Systems and methods described herein provide the ability to pass computed results from one execution unit (e.g., a datapath unit) to other, parallel execution units (e.g., integer units), in a manner that minimizes overhead (e.g., requires few clock cycles).

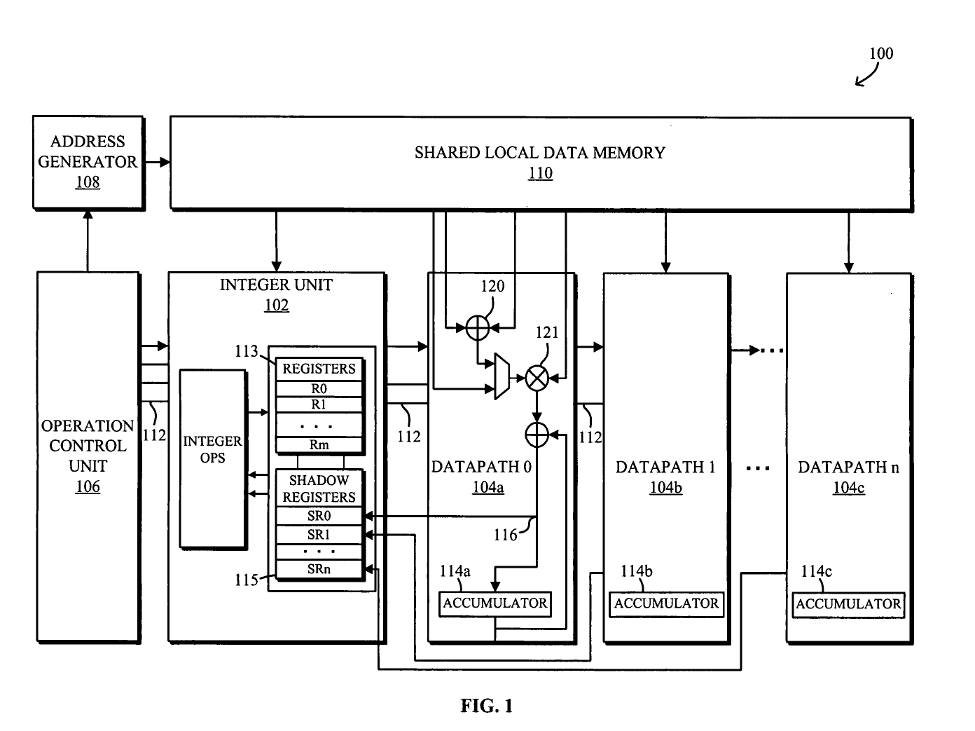

FIG. 1 shows an example of a processor 100 with multiple execution units. In particular, example processor 100 includes an integer execution unit 102 and a collection of n datapath execution units 104a-104c. Processor 100 also includes an operation control unit 106, an address generator 108, and shared local memory 110.

The operation of processor 100 is controlled by control unit 106, which sends function control signals (typically derived from instructions that the control unit is executing) to the various components of the system. For example, control unit 106 may send function control signals to integer unit 102 and datapaths 104 over dedicated control lines 112, specifying the operations to be performed on data read from memory 110.

Datapaths 104 are generally designed to perform numerically intensive operations, such as those involved in digital signal processing (DSP) calculations, while integer unit 102 performs somewhat less intensive, but more general-purpose, integer operations, such as those performed by reduced instruction set (RISC) type processors. Integer unit 102 and datapath units 104 perform their processing in parallel, and it will often be desirable to share results among them. For example, it may be desirable for datapath units 104 to pass results to integer unit(s) 102 for further processing, as might be the case if datapath units 104 provide intermediate results for a larger calculation.

As shown in FIG. 1, datapaths 104 and integer unit 102 each have their own register(s) 113, 114 for storing the results of their respective computations. Thus, for example, if it were desired to share the results of computations performed by a datapath unit 104 with integer unit 102, the contents of the datapath's accumulator register 114 could be transferred to integer unit 102.

This could be accomplished in a variety of ways. One technique would be to copy the accumulator data to shared local data memory 110, where it could be retrieved by integer unit 102. Another technique would be to copy the accumulator data to an external register that is shared by the datapath unit and the integer unit. A problem with both of these approaches, however, is that they are relatively slow, since each involves multiple steps which will typically be performed on separate clock cycles (e.g., one clock cycle to copy data from accumulator register 114 to shared local data memory 110, another clock cycle to write data from shared local data memory 110 to integer unit 102).

Thus, in one embodiment the data that is written to the datapath accumulator registers 114 is also copied directly to parallel, “shadow registers” 115 in integer unit 102. As shown in FIG. 1, in one embodiment shadow registers 115 are connected directly to the datapath units to which they correspond. For example, shadow registers 115 and accumulator registers 114 can share a common input 116. In one embodiment, data is written to shadow registers 115 at substantially the same time as it is written to the accumulator registers (e.g., on the same clock cycle). Alternatively, data could be written to the shadow registers at some other interval (e.g., after a predefined number of clock cycles), in which case the transmission could be controlled by a multiplexer or other logic gate, and/or by control unit 106. This might be desirable, for example, if power consumption were of particular concern.

The logic shown in datapath 104a is illustrative of the type of logic that might be found in each of the datapaths 104, although it will be appreciated that any suitable logic could be used. As shown in FIG. 1, datapath 104a might contain a multi-input pre-adder 120 and multiplier 121, in addition to its accumulator register 114a. In one embodiment, these elements can be reconfigured by control unit 106 to perform different functions, such fast Fourier transforms (FFTs), filter operations, and/or the like.

In some embodiments, the control unit 106 itself may be reconfigurable. Alternatively, or in addition, the elements in the datapath units may be reconfigurable, at least in the sense of performing operations in accordance with control signals received from control unit 106. In one embodiment, the signals used to reconfigure the various execution units (e.g., the signals used to specify the functions they are to perform) are sent on each clock cycle by a state machine run on control unit 106.

It should be appreciated that FIG. 1 is provided for purposes of illustration, and not limitation, and that the systems and methods described herein can be practiced with devices and architectures that lack some of the components and features shown in FIG. 1 and/or that have other components or features that are not shown. For example, although FIG. 1 shows a multi-execution unit processor with one integer unit and n datapaths, it should be appreciated that any suitable combination of integer units, datapath units, and/or other execution units could be used, and that data could be shared between them using any suitable combination of registers and shadow registers. For example, one or more datapath units 104 might contain their own set of one or more shadow registers for receiving intermediate results from other datapath units 104 and/or integer unit 102. As another example, each execution unit (e.g., datapaths 104 and integer unit(s) 102) could contain a shadow register (or multiple shadow registers) corresponding to each of the other execution units. Thus, it should be appreciated that any suitable configuration of execution units containing shadow registers could be used to achieve the desired degree of integration for a particular application.

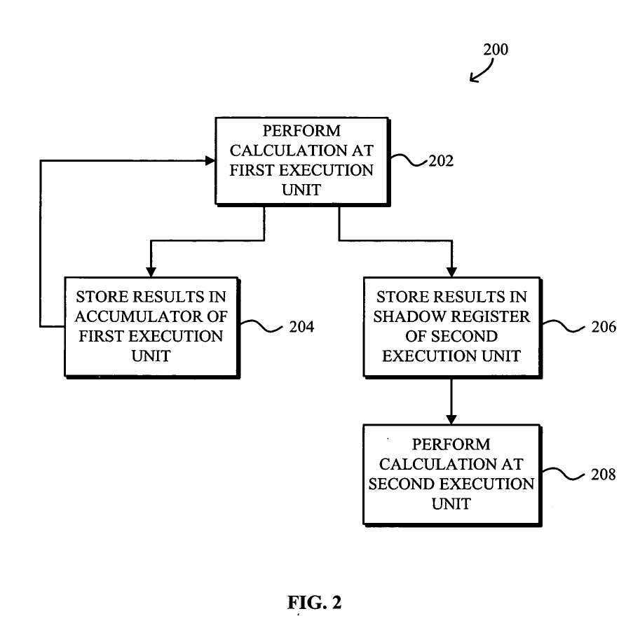

FIG. 2 illustrates a process 200 for facilitating inter-execution unit communication, such as that described above. Referring to FIG. 2, a first execution unit (e.g., a datapath unit) performs a calculation (block 202), and stores the result in its accumulator register(s) (block 204). In a substantially simultaneous manner (e.g., on the same clock cycle), the result is also stored in a parallel “shadow” register in another execution unit (e.g., an integer unit) (block 206), where it can be used in future calculations (block 208).

It should be appreciated that a variety of changes or additions could be made to the basic process shown in FIG. 2. For example, without limitation, instead of transferring data to the first execution unit's accumulator register and to the second execution unit's shadow register on the same clock cycle, data could instead be transferred at some other frequency. For example, the results could be copied to the shadow register every n clock cycles, where n is any suitable number. In one embodiment, the interval at which data is copied is controlled by the operation control unit 106 via dedicated function control lines 112.

A combination of an integer unit and multiple datapath units operating in parallel with no shared execution hardware, such as that shown in FIG. 1, can provide a low power solution for performing physical layer processing in an architecture capable of processing multiple communications protocols. As described in connection with FIG. 1, the calculated results contained in the datapath accumulators can always (or selectively) be copied to shadow registers in the integer unit, thus providing the integer unit with immediate access to the datapaths' calculated results, without requiring extra instructions and/or memory allocation to move data to and from shared local memory or a shared register.

Thus, systems and methods have been described that can be used to improve the coupling of parallel integer and datapath units without requiring shared execution hardware, shared external memory, shared register hardware, or the use of data move instructions that consume extra clock cycles. A tight coupling of two processing units improves processing efficiency by reducing the overhead associated with inter-processing unit data transfers, and can thus be used to improve the efficiency of physical layer processing on a common set of hardware, thereby enabling programmable or reconfigurable processors to compete more effectively with dedicated hardware systems.

The techniques described above can be used in a variety of computing systems. For example, a processor such as that shown in FIG. 1 can be used in a system that provides support for multiple communications protocols and standards, such as a system that implements the reconfigurable communications architecture (RCA) developed by Intel Corporation of Santa Clara, Calif.

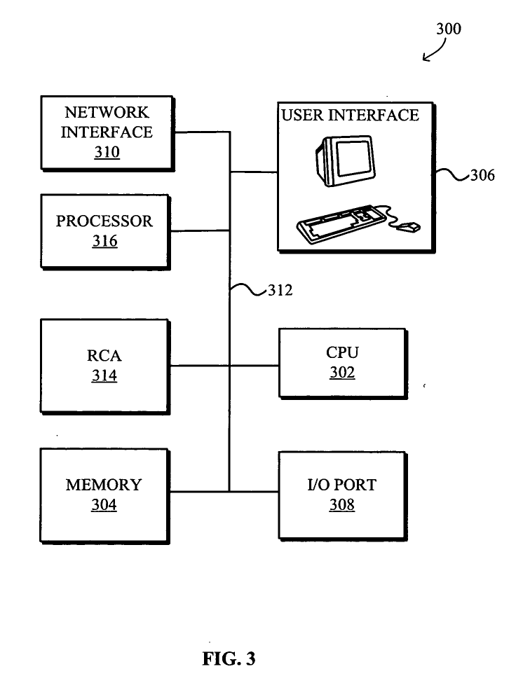

FIG. 3 shows an example of such a system. In one embodiment, system 300 comprises a general-purpose computing device such as a personal computer, PDA, or cellular telephone. Such a system will typically include a processor (CPU) 302, memory 304, a user interface 306, an input/output port (I/O) 308, a network interface 310, and a bus 312 for connecting the aforementioned elements. The operation of system 300 will typically be controlled by processor 302 operating under the guidance of programs stored in memory 304. Memory 304 will generally include both high-speed random-access memory (RAM), and non-volatile memory such as magnetic or optical disk and read-only memory (ROM).

As shown in FIG. 3, system 300 also includes a variety of special-purpose reconfigurable and/or reprogrammable processors or accelerators 314, 316, for enabling system 300 to communicate with other systems and networks using any of a variety of protocols and/or network connections (e.g., local area network (LAN), wide area network (WAN), virtual private network (VPN), etc.). For example, system 300 may include a chip 314 implementing the reconfigurable communications architecture (RCA). In some embodiments, these processors may be integrated directly with processor 302, or, as shown in FIG. 3, may comprise separate chips that communicate with processor 302 over bus 312. These processors may perform a variety of specialized functions, and may make use of the integration techniques and architectures described in connection with FIGS. 1 and 2 for improved efficiency. For example, RCA chip 314 may include an array of processors, such as filter micro-coded accelerators (filter MCAs) and the like, some of which have the architecture of processor 100 in FIG. 1.

It should be appreciated that FIG. 3 is provided for purposes of illustration and not limitation, and that the techniques described herein can be practiced with systems and devices other than that shown in FIG. 3. Moreover, while FIGS. 1 and 3 illustrate an exemplary processor, and a computing system incorporating one or more such processors, it will be appreciated that the systems and methods described herein can be implemented using other hardware, firmware, and/or software. Thus, while several embodiments are described and illustrated herein, it will be appreciated that they are merely illustrative. Other embodiments are within the scope of the following claims.

1. A system comprising:
a plurality of execution units, each of said execution units including one or more data registers and one or more shadow registers, each shadow register being communicatively coupled to at least one data register in another execution unit;
a memory unit; and
a control unit operable to issue control signals to the execution units, the control signals being operable to facilitate processing of data read from the memory unit, and to enable data transfers between the execution units.

2. A system as in claim 1, in which each shadow register is connected to an input to a data register, such that data written to the data register is also written to the shadow register.

3. A system as in claim 1, in which the plurality of execution units include one or more integer execution units and one or more datapath execution units.

4. A system as in claim 2, in which the data register comprises an accumulator register.

5. A system comprising:
a control unit;
a first execution unit, the first execution unit including a first data register; and
a second execution unit, the second execution unit including a second register containing a copy of the first data register's contents, the second register being communicatively coupled to an input of the first data register.

6. The system of claim 5, in which the first execution unit comprises a datapath execution unit.

7. The system of claim 5, in which the second execution unit comprises an integer execution unit.

8. The system of claim 6, in which the second execution unit comprises an integer execution unit.

9. The system of claim 7, in which the first execution unit comprises an integer execution unit.

10. The system of claim 5, in which the first data register comprises an accumulator register.

11. A system comprising:
a general purpose processor;
a memory unit;
a user interface; and
a plurality of special-purpose processors, at least one of the special purpose processors comprising:
a plurality of datapath units, each of said datapath units including a data register;
an integer unit, the integer unit including one or more shadow registers, each shadow registers being communicatively coupled to a data register in a datapath unit; and
a control unit operable to issue control signals to the integer unit and the datapath units.

12. The system of claim 11, in which the plurality of processors form part of a chip designed in accordance with a reconfigurable communications architecture.

13. A method comprising:
at a first execution unit, calculating a first result;
storing the first result in a first data register at the first execution unit; and
transferring the first result from the first execution unit to a first shadow register in a second execution unit.

14. The method of claim 13, in which the acts of storing the first result in the first data register and transferring the first result to a first shadow are performed during the same clock cycle.

15. The method of claim 13, further comprising:
at a third execution unit, calculating a second result;
storing the second result in a second data register at the third execution unit; and
transferring the second result from the third execution unit to a second shadow register in the second execution unit.

16. The method of claim 15, in which the act of transferring the first result from the first execution unit to the first shadow register is performed during the same clock cycle as the act of transferring the second result from the third execution unit to the second shadow register.

17. The method of claim 15, in which the act of transferring the first result from the first execution unit to the first shadow register is performed at a frequency independent of the act of transferring the second result from the third execution unit to the second shadow register.

18. The method of claim 13, further comprising:
at the second execution unit, calculating a second result;
storing the second result in a second data register at the second execution unit; and
transferring the second result from the second execution unit to a third shadow register in a third execution unit.

19. The method of claim 13, in which the first execution unit comprises a datapath execution unit and the second execution unit comprises an integer execution unit.

20. The method of claim 13, in which the second execution unit comprises an integer execution unit and the first execution unit comprises an integer execution unit.

21. The method of claim 13, in which the second execution unit comprises a datapath execution unit and the first execution unit comprises a datapath execution unit.
